(19) United States
(12) Patent Application Publication
(10) Pub. No.: US 2006/0117529 A1
(43) Pub. Date: Jun. 8, 2006

(54) Hinge assembly with lubricant storing receptacle

(75) Inventors: Chao Duan, Shenzhen (CN); Ying-Liang Tu, Shenzhen (CN); Mao-Fa Jiang, Shenzhen (CN); Qin Ou-Yang, Shenzhen (CN); Shun Guo, Shenzhen (CN); Chia-Hua Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH Co.,LTD, Shindian City (CN)

(21) Appl. No.: 11/292,517

(22) Filed: Dec. 2, 2005

(30) Foreign Application Priority Data
Dec. 3, 2004 (CN) 200420102393.9

(51) Int. Cl. E05F 1/08

(52) U.S. Cl. 16/303

(57) ABSTRACT

A hinge assembly (10) includes a shaft (20), a follower (22), a cam (30), at least one oil storing receptacle (33), and an urging means (40). The shaft has a securing portion (21) formed at a first end thereof. The follower connects with the shaft. The cam is essentially in the shape of a cylinder, and includes a cam surface (32) and defines a cam hole (31) extending therethrough. The cam hole receives the shaft therethrough. In one embodiment, a first end of the urging means abuts an opposite second end of the shaft, and an opposite second end of the urging means biases the cam. Three oil storing receptacles are disposed generally between the cam and the urging means. The cam surface of the cam is rotatably and movably engaged with the follower under force of the urging means.

### FIELD OF THE INVENTION

The present invention relates to hinge assemblies, and particularly to a hinge assembly for foldable electronic devices such as mobile telephones, electronic notebooks, and so on.

### GENERAL BACKGROUND

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the main body. The other housing, called the cover, normally contains fewer electronic components than the main body. Other foldable electronic devices have all the electronics in the main body, with the cover containing no electronics. Various types of hinge assemblies are used to join a main body and a cover of a foldable electronic device, so that the cover can unfold up from and fold down upon the main body. Manufacturers are constantly seeking to reduce the volume, size and weight of portable foldable electronic devices. Thus, it is desirable that the hinge assembly coupling the main housing with the cover is modularized and miniaturized. A modularized hinge assembly has moving parts such as a cam member, a follower and a spring held together in a unified structure. The structure is easily and quickly attached to the main body and the cover during mass production. A miniaturized hinge assembly has as few parts as possible, with the parts being as small as practicable.

One kind of conventional foldable electronic device with a hinge assembly is configured as follows. The foldable electronic device is typically a mobile phone. The hinge assembly includes a housing secured to a main body of the mobile phone, a spring received in the housing, a rotary cam rod, and a shaft with a follower and a connecting portion. The rotary cam rod is received in the housing and engages with the housing. One end of the spring contacts an inner wall of the housing, and the other end of the spring resists one end of the rotary cam rod. The shaft is passed through the rotary cam rod and the spring in that order.

Although the above-described hinge assembly is suitable for some foldable electronic devices, the spring and the rotary cam rod are in direct contact with each other. Dry friction is produced between the spring and the rotary cam rod because of relative rotation therebetween. This wastes energy and causes abrasion of the spring and the rotary cam rod. The abrasion may eventually lead to premature malfunction or failure of the hinge assembly.

What is needed, therefore, is a hinge assembly which can have a relatively long working lifetime and which is energy efficient and convenient to use.

### SUMMARY

In a first preferred embodiment, a hinge assembly is provided for joining a cover to a main body of a foldable electronic device. The hinge assembly includes a shaft, a follower, a cam, a plurality of oil storing receptacles, and an urging means. The shaft has a securing portion formed at a first end thereof, for connecting to the main body of the foldable electronic device. Preferably, the follower is integrally connected with the shaft. The cam is essentially in the shape of a cylinder, and is for connecting to the cover of the foldable electronic device. The cam includes a cam surface, and defines a cam hole extending therethrough. The cam hole receives the shaft therethrough. A first end of the urging means abuts a second end of the shaft, and an opposite second end of the urging means biases the cam. The oil storing receptacles are disposed generally between the cam and the urging means. The cam surface of the cam is rotatably and movably engaged with the follower under force of the urging means.

A main advantage of the above-described hinge assembly is that the oil storing receptacles are disposed between the cam and the urging means. The oil storing receptacles store oil, and the oil flows from the oil storing receptacles to lubricate the cam and the urging means if the cam is rotated relative to the urging means. This reduces friction between the cam and the urging means. Accordingly, when the hinge assembly is assembled in a mobile phone, the energy required in opening the cover of the mobile phone is reduced. Furthermore, the working lifetime of the hinge assembly is prolonged.

In a second preferred embodiment, a hinge assembly is provided for joining a cover to a main body of a foldable electronic device. The hinge assembly includes a shaft, a follower, a cam, a plurality of oil storing receptacles, and an urging means. The shaft has a securing portion formed at a first end thereof, and a latching portion formed at an opposite second end thereof. The securing portion is for connecting to the cover of the foldable electronic device. Preferably, the follower is integrally connected with the shaft. The cam is essentially in the shape of a cylinder, and is for connecting to the main body of the foldable electronic device. The cam includes a cam surface, and defines a cam hole extending therethrough. The cam hole receives the shaft therethrough. A first end of the urging means biases the latching portion, and an opposite second end of the urging means abuts the cam. The oil storing receptacles are disposed generally between the urging means and the latching portion of the shaft. The follower is rotatably and movably engaged with the cam surface of the cam under force of the urging means.

A main advantage of the above-described hinge assembly is that the oil storing receptacles are disposed between the urging means and the latching portion of the shaft. The oil storing receptacles store oil, and the oil flows from the oil storing receptacles to lubricate the urging means and the latching portion if the latching portion is rotated relative to the urging means. This reduces friction between the latching portion and the urging means. Accordingly, when the hinge assembly is assembled in a mobile phone, the energy required in opening the cover of the mobile phone is reduced. Furthermore, the working lifetime of the hinge assembly is prolonged.

Other advantages and novel features will become more apparent from the following detailed description when taken in conjunction with the accompanying drawings, in which:

### BRIEF DESCRIPTION OF THE DRAWINGS

FIG. 1 is an isometric view of a flip type mobile phone including a cover, a main body, and a hinge assembly according to a first preferred embodiment of the present invention, the hinge assembly being shown with dashed lines;

FIG. 2 is an enlarged, exploded, isometric view of the hinge assembly of FIG. 1;

FIG. 3 is similar to FIG. 2, but viewed from another aspect;

FIG. 4 is an enlarged, assembled view of the hinge assembly of FIG. 1;

FIG. 5 is a cross-sectional view taken along line V-V of FIG. 4;

FIG. 6 is an enlarged, exploded, isometric view of a hinge assembly according to an alternative embodiment of the first preferred embodiment of the present invention, the hinge assembly including a washer defining a plurality of oil storing receptacles;

FIG. 7 is an enlarged, exploded, isometric view of a hinge assembly according to a second preferred embodiment of the present invention; and

FIG. 8 is an enlarged, exploded, isometric view of a hinge assembly according to an alternative embodiment of the second preferred embodiment of the present invention, the hinge assembly including a washer defining a plurality of oil storing receptacles.

### DETAILED DESCRIPTION OF PREFERRED EMBODIMENTS

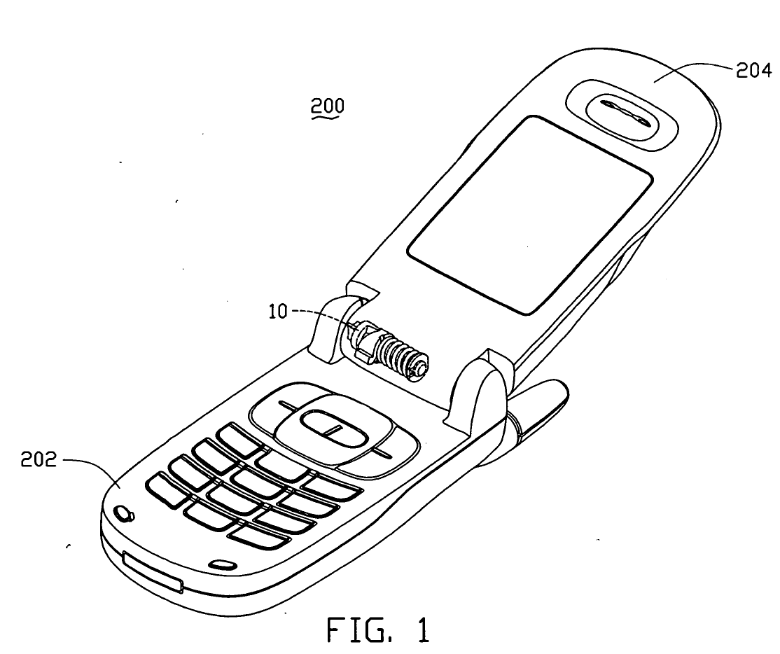

Referring now to the drawings, FIG. 1 shows an electronic device like a flip type mobile phone 200, which includes a hinge assembly 10 according to a first preferred embodiment of the present invention. The mobile phone 200 has a main body 202 and a cover 204. The main body 202 and the cover 204 are pivotally connected to each other via the hinge assembly 10. It should be noted that the hinge assembly 10 is also used to interconnect components like a main body and a cover of any of various different kinds of foldable electronic devices other than the mobile phone 200.

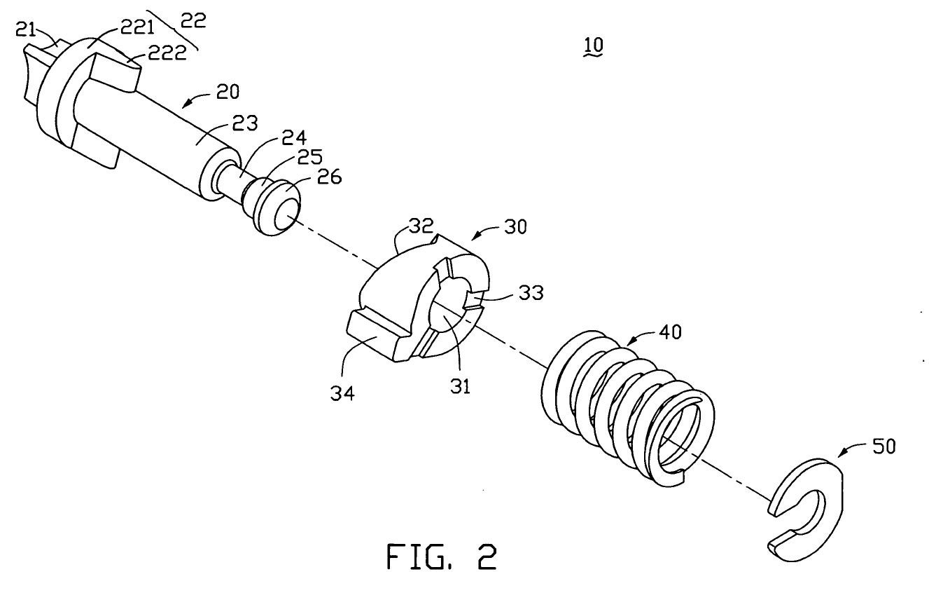

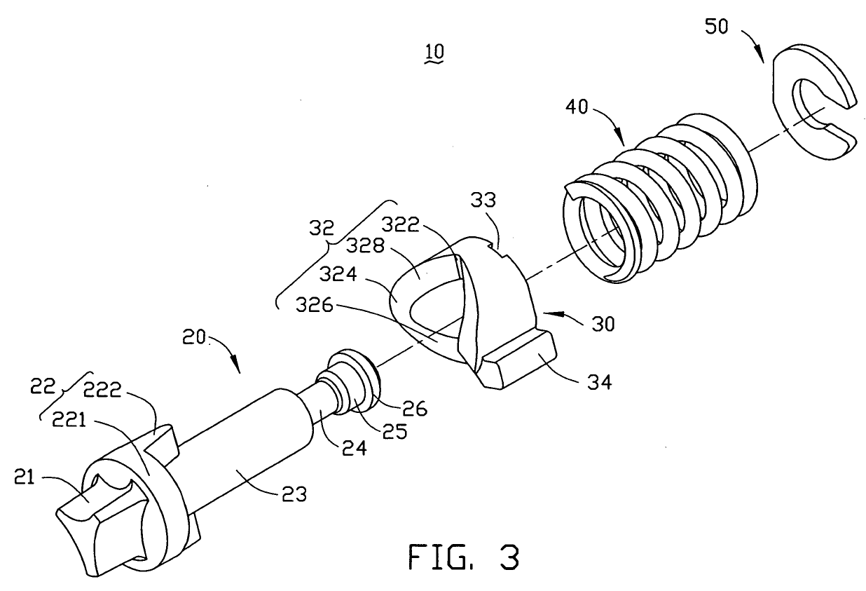

Referring now to FIGS. 2 and 3, the hinge assembly 10 includes a shaft 20, a cam 30, a plurality of oil storing receptacles 33, a spring 40 functioning as an elastic urging means, and a clip 50. In the illustrated embodiment, there are three oil storing receptacles 33, and the oil storing receptacles 33 are defined in a second end of the cam 30. The shaft 20 extends through the cam 30, the spring 40, and the clip 50, thereby integrating the hinge assembly 10.

The shaft 20 includes in sequence a securing portion 21 formed at a first end thereof, a follower 22 adjacent the securing portion 21, a large diameter portion 23, a neck portion 24, and a small diameter portion 25. The securing portion 21 is for engaging with the main body 202 of the mobile phone 200. The follower 22 includes an enlarged cylindrical portion 221, and two symmetrically opposite finger portions 222 extending in an axial direction and adjoining one end of the large diameter portion 23. The small diameter portion 25 has a latching portion 26 formed at one end thereof. A diameter of the latching portion 26 is larger than that of the small diameter portion 25.

The cam 30 is a generally cylindrical body, and defines a cam hole 31. The cam 30 has a cam surface 32 formed at a first end thereof, and has the three oil storing receptacles 33 provided in an opposite second end thereof. In the illustrated embodiment, each oil storing receptacle 33 is substantially a groove. The oil storing receptacles 33 are evenly spaced apart from each other around the cam hole 31. In alternative embodiments, there may instead be one, two, four or more oil storing receptacles 33. Further, each oil storing receptacle 33 can alternatively have another suitable shape. The cam surface 32 includes two valleys 322, two peaks 324, two moderate inclined planes 326, and two steep inclined planes 328. Preferably, the valleys 322 are located 180 degrees opposite from each other, and the peaks 324 are located 180 degrees opposite from each other. The cam 30 also has a protrusion 34 formed on an outer peripheral wall thereof, the protrusion 34 being oriented parallel to the central axis of the cam 30. The protrusion 34 is for engaging with the cover 204 of the mobile phone 200.

The spring 40 is helical and preferably metallic, with an inner diameter larger than a diameter of the large diameter portion 23 of the shaft 20. Thus the spring 40 can be located around the shaft 20. A first end of the spring 40 resists the clip 50, and an opposite second end of the spring 40 resists the second end of the cam 30.

The clip 50 is C-shaped, and is made of an elastic material. A first main surface of the clip 50 resists the spring 40, and an opposite second main surface of the clip 50 resists the latching portion 26 of the shaft 20.

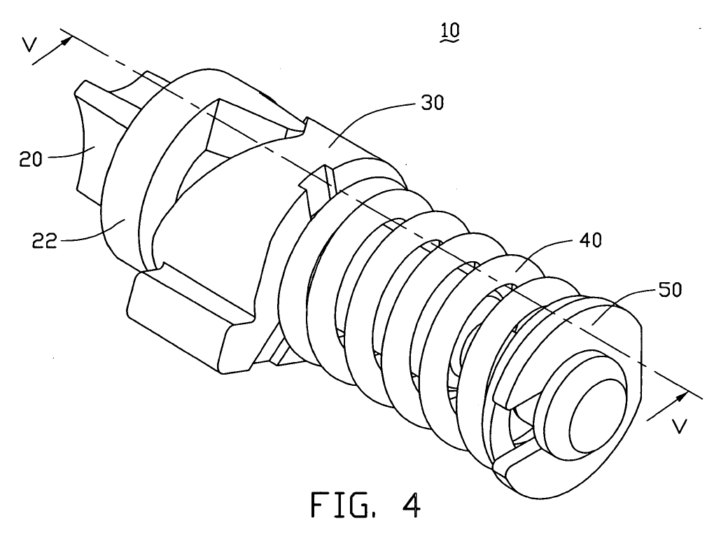

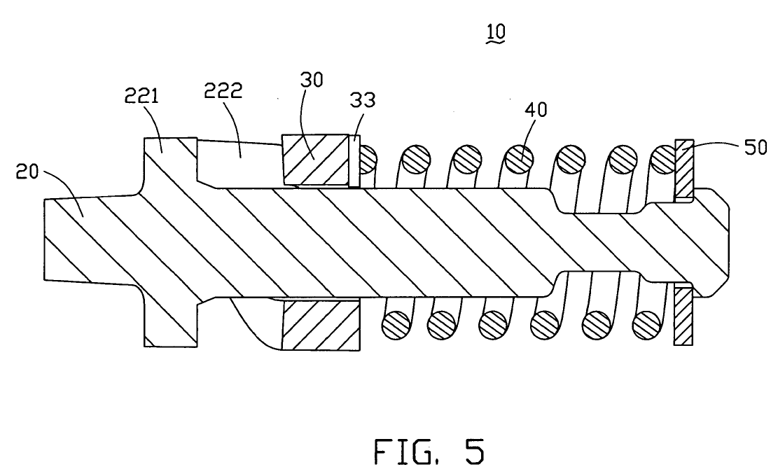

Referring to FIGS. 4 and 5, in assembly of the hinge assembly 10, firstly, the shaft 20 is passed through the cam hole 31 of the cam 30 and the spring 40 in that order. The clip 50 is snappingly engaged around the small diameter portion 25 of the shaft 20, such that the spring 40 is slightly compressed. The second end of the spring 40 resists the second end of the cam 30, and the first end of the spring 40 resists the first surface of the clip 50. The latching portion 26 of the shaft 20 resists the second surface of the clip 50, and prevents the clip 50 from falling off from the shaft 20. The cam surface 32 of the cam 30 always contacts the finger portions 222 no matter what rotational position the cam 30 is in, because of urging force of the spring 40. Finally, lubricant is stored in the oil storing receptacles 33. The lubricant may for example be lubricating oil. The hinge assembly 10 is thus completely assembled.

In use of the hinge assembly 10, the protrusion 34 is engaged in a cavity (not shown) of the cover 204 of the mobile phone 200, and the securing portion 21 of the shaft 20 is engaged in the main body 202 of the mobile phone 200. When the cover 204 of the mobile phone 200 is in a fully open position (or fully closed position), the finger portions 222 of the shaft 20 are located in the valleys 322 of the cam 30 and are engaged with the valleys 322. When the cover 204 of the mobile phone 200 is rotated between an open position and a closed position (or vice versa), the cam 30 rotates along with the cover 204, while the shaft 20 remains fixed in the main body 202 of the mobile phone 200. As a result, the finger portions 222 ride along the moderate inclined planes 326 of the cam surface 32 from the valleys 322 to the peaks 324, with the cam 30 moving toward the clip 50 and compressing the spring 40. Once the finger portions 222 pass over the peaks 324, the spring 40 decompresses and drives the cam 30 back toward the cylindrical portion 221, with the finger portions 222 riding along the steep inclined planes 328 from the peaks 324 to the valleys 322. The cover 204 is thus rotated automatically to the fully open position (or fully closed position) under decompression force of the spring 40. Accordingly, the cover 204 is moved 180 degrees relative to the main body 202, with the finger portions 222 once again mating in the valleys 322. In this way, the cover 204 is opened (or closed). Preferably, the structures of the cover 204 and the main body 202 are adapted to control the degree of rotation of the hinge assembly 10, such that the finger portions 222 can be held in one or more particular locations between the valleys 322 and the peaks 324. During the above-described processes, if the cam 30 is rotated relative to the spring 40, some oil flows from the oil storing receptacles 33 and lubricates the cam 30 and the spring 40. This reduces the friction between the cam 30 and the spring 40.

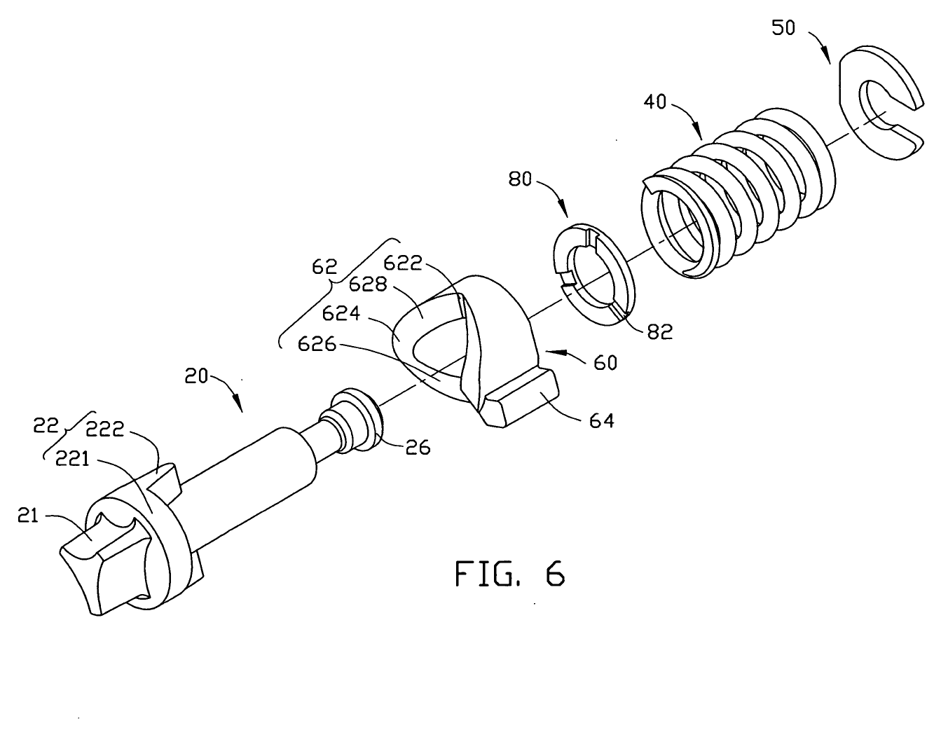

Referring to FIG. 6, in an alternative embodiment, a plurality of oil storing receptacles 82 can be provided on a washer 80. That is, a first surface portion of the washer 80 defines the oil storing receptacles 82 and resists a cam 60, and an opposite second surface of the washer 80 resists the spring 40. Each oil storing receptacle 82 is substantially a groove or has another suitable shape. The cam 60 is similar to the cam 30 of the first preferred embodiment, and includes a cam surface 62 and a protrusion 64. The cam surface 62 includes two valleys 622, two peaks 624, two moderate inclined planes 626, and two steep inclined planes 628.

In further alternative embodiments, the follower 22 can be a separate element that is not integrally formed with the shaft 20. In such case, the follower 22 defines a shaft hole, and has a cam surface or finger portions. The spring 40 can be made of nonmetallic material such as plastic. Further, the spring 40 can instead be another kind of elastic element or urging means known in the art, such as a resilient cylinder. The clip 50 can be omitted, in which case the spring 40 directly resists the latching portion 26. There can be more than one protrusion 34.

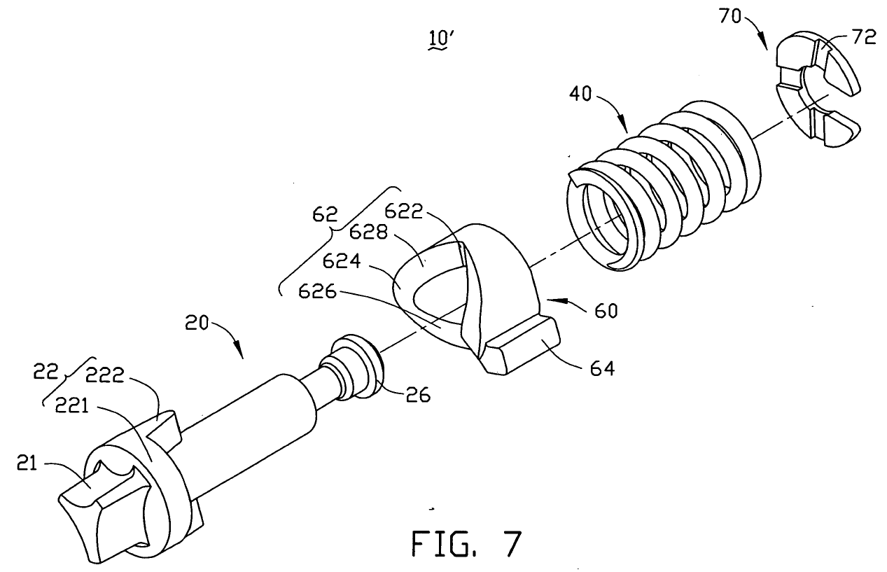

Referring to FIG. 7, a hinge assembly 10′ according to a second preferred embodiment of the present invention is similar to the hinge assembly 10, except that the hinge assembly 10′ has a cam 60 and a clip 70. The cam 60 has a cam surface 62 formed at one end thereof. One surface portion of the clip 70 opposite to the spring 40 defines a plurality of oil storing receptacles 72. In the illustrated embodiment, there are three oil storing receptacles 72. The hinge assembly 10′ can be used to pivotally connect the main body 202 and the cover 204 of the mobile phone 200. The securing portion 21 of the shaft 20 is used to connect with the cover 204, and a protrusion 64 of the cam 60 is used to connect with the main body 202. In such case, there is no relative rotation between the cam 60 and the spring 40, whereas there is relative rotation between the clip 70 around the shaft 20 and the spring 40. Accordingly, if the clip 70 is rotated relative to the spring 40, some lubricant such as oil flows from the oil storing receptacles 72 to lubricate the clip 70 and the spring 40. This reduces friction between the clip 70 and the spring 40.

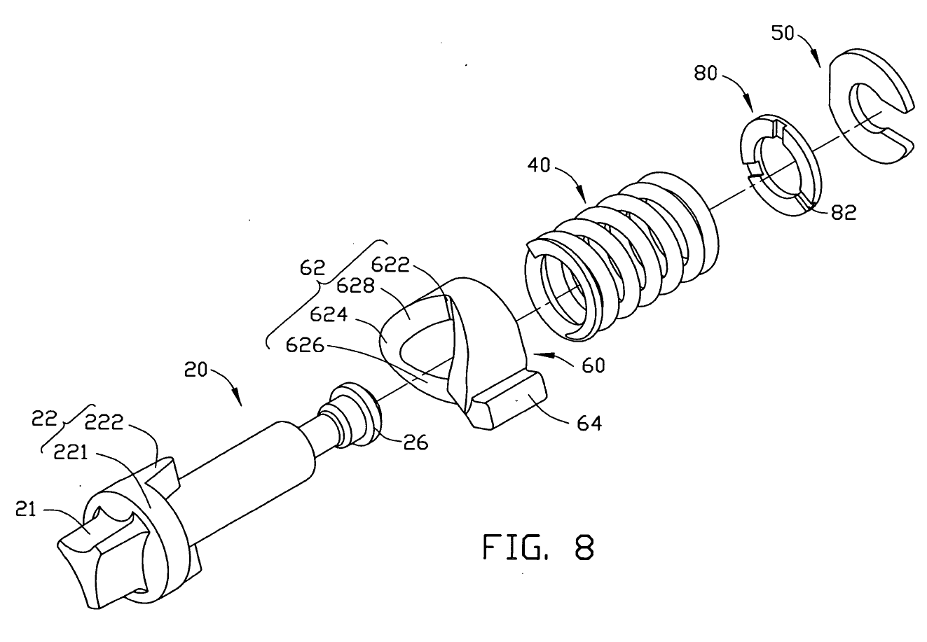

Referring to FIG. 8, in an alternative embodiment, a plurality of oil storing receptacles 82 can be provided on a washer 80. That is, a first surface portion of the washer 80 defines the oil storing receptacles 82 and resists the cam 60, and an opposite second surface of the washer 80 resists a clip 50. Each oil storing receptacle 82 is substantially a groove or has another suitable shape.

In further alternative embodiments, the clip 70 can be omitted. In such case, the oil storing receptacles 72 are disposed between the spring 40 and the latching portion 26 of the shaft 20. The hinge assembly 10′ may have still further alternative embodiments, similar to the alternative embodiments described above in relation to the hinge assembly 10.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A hinge assembly for joining a cover to a main body of a foldable electronic device, comprising:
a shaft having a first end and a second end, and comprising a securing portion formed at the first end;
a follower connecting with the shaft;
a cam essentially in the shape of a cylinder, comprising a cam surface and defining a cam hole extending therethrough, the cam hole receiving the shaft therethrough;
a lubricant storing receptacle; and
an urging means, a first end of the urging means abutting the second end of the shaft, an opposite second end of the urging means biasing the cam, wherein the lubricant storing receptacle is disposed generally between the urging means and the cam, and the cam surface of the cam is rotatably and movably engaged with the follower under force of the urging means.

2. The hinge assembly as claimed in claim 1, wherein the lubricant storing receptacle comprises a groove, which is defined in an end of the cam.

3. The hinge assembly as claimed in claim 1, further comprising a washer, wherein the lubricant storing receptacle comprises a groove defined in a first surface portion of the washer, the first surface of the washer resists the cam, and an opposite second surface of the washer resists the urging means.

4. The hinge assembly as claimed in claim 1, wherein the follower and the shaft are integrally formed, the follower is adjacent the securing portion and comprises two finger portions, and the cam surface of the cam is rotatably and movably engaged with the finger portions.

5. The hinge assembly as claimed in claim 1, wherein the second end of the shaft comprises a clip, and the urging means abuts the clip.

6. The hinge assembly as claimed in claim 1, wherein the urging means is a helical spring located around the shaft.

7. The hinge assembly as claimed in claim 1, wherein the cam surface has a pair of opposite valleys and a pair of opposite peaks.

8. The hinge assembly as claimed in claim 1, wherein the second end of the shaft comprises a latching portion, and the urging means abuts the latching portion.

9. A hinge assembly for joining a cover to a main body of a foldable electronic device, comprising:
a shaft comprising a securing portion formed at a first end thereof, and a latching portion formed at an opposite second end thereof;
a follower connecting with the shaft;
a cam essentially in the shape of a cylinder, comprising a cam surface and defining a cam hole extending therethrough, the cam hole receiving the shaft therethrough;
a lubricant storing receptacle; and
an urging means, a first end of the urging means biasing the latching portion, an opposite second end of the urging means abutting the cam, wherein the lubricant storing receptacle is disposed generally between the urging means and the latching portion, and the follower is rotatably and movably engaged with the cam surface of the cam under force of the urging means.

10. The hinge assembly as claimed in claim 9, wherein the lubricant storing receptacle comprises a groove defined in the latching portion of the shaft.

11. The hinge assembly as claimed in claim 9, further comprising a washer, wherein the lubricant storing receptacle comprises a groove defined in a first surface portion of the washer, the first surface of the washer resists the urging means, and an opposite second surface of the washer resists the latching portion of the shaft.

12. The hinge assembly as claimed in claim 9, wherein the follower and the shaft are integrally formed, the follower is adjacent the securing portion and comprises two finger portions, and the finger portions are rotatably and movably engaged with the cam surface of the cam.

13. The hinge assembly as claimed in claim 9, wherein the urging means is a helical spring located around the shaft.

14. The hinge assembly as claimed in claim 9, wherein the latching portion comprises a clip portion, and the lubricant storing receptacle is disposed generally between the urging means and the clip portion.

15. The hinge assembly as claimed in claim 9, wherein the cam surface has a pair of opposite valleys and a pair of opposite peaks.

16. An electronic device comprising:
a main body of said electronic device;
a cover of said electronic device capable of abutting against a side of said main body to cover said side and movable away relative to said main body to expose said side of said main body; and
a hinge assembly disposed between said main body and said cover so as to controllably conduct movement of said cover relative to said main body, said hinge assembly comprising at least two relatively movable elements capable of conducting said movement of said cover, and an urging means capable of movably abutting against at least one of said at least two relatively movable elements for contributing to said conducting of said at least two movable elements, a lubricant storing receptacle disposed along an abutting interface between said urging means and said at least one of said at least two movable elements so as to provide an access for lubricant into said interface.

17. The electronic device as claimed in claim 16, wherein said at least two movable elements comprise a shaft and a cam relatively movably installable to said shaft.
